(19) United States
(12) Patent Application Publication
(10) Pub. No.: US 2018/0245635 A1
(43) Pub. Date: Aug. 30, 2018

(54) RHEOMETER HAVING A GAS BEARING

(71) Applicant: Thermo Electron (Karlsruhe) GmbH, Karlsruhe (DE)

(72) Inventors: Wolfgang PLATZEK, Daxlanden (DE); Uwe BAUER, Ruelzheim (DE)

(21) Appl. No.: 15/754,724

(22) PCT Filed: Aug. 11, 2016
(86) PCT No.: PCT/EP2016/001384

§ 371 Date: Feb. 23, 2018

(30) Foreign Application Priority Data
Aug. 25, 2015 (DE) 10 2015 010 875.1

(51) Int. Cl. F16C 32/06; F16C 33/16; G01N 11/14

(52) U.S. Cl. CPC F16C 32/0618; F16C 32/0625; F16C 2370/00; G01N 11/14; F16C 2206/40; F16C 33/16

(57) ABSTRACT

A rheometer has a shaft, which is supported rotatably in a gas bearing. The gas bearing has a first bearing element (rotor) attached to the shaft and a second bearing element (stator) that surrounds the first bearing element (rotor) with a distance between the two, forming a bearing gap. At least sections of the second bearing element (stator) are made from a gas-permeable material, and gas is passed through them in such manner that a gas cushion is formed in the bearing gap, by which the first bearing element (rotor) and the shaft are supported without direct contact between the two. It is provided that the first bearing element (rotor) is also made from a gas-permeable material, at least in the areas that face the second bearing element (stator), and which the gas penetrates and forms a preferably static gaseous layer close to the surface as a result of the dynamic pressure or backpressure of the gas.

### CROSS-REFERENCE TO RELATED APPLICATIONS

This application is a U.S. national stage application under 35 USC § 371 of international application serial no. PCT/EP2016/001384, filed Aug. 11, 2016, which claims the priority benefit to German patent application no. 10 2015 010 875.1, filed Aug. 25, 2015, the entire disclosure of which is incorporated by reference.

The invention relates to a rheometer with a shaft that is rotatably supported in a gas bearing, where the gas bearing comprises a first bearing element (rotor) attached to the shaft and a second bearing element (stator) which surrounds the first bearing element (rotor) with a space between the two, forming a bearing gap, wherein at least in part of the second bearing element (stator) consists of a gas-permeable material and allows gas to flow through in such manner that a gas cushion is formed in the bearing gap, which supports the first bearing body (rotor) and the shaft without direct contact.

A similar gas bearing, also known as an aerostastic bearing or air bearing, is often used in rheometers because it allows microstructure analyses to be performed reliably with very small torques and deformations.

Aerostatic bearings belong to the group of gas- or air-lubricated bearings. The gas or air medium is forced through the stator into the bearing gap from the outside, so that a gas cushion is formed in the bearing gap. The gas cushion and the gas pressures and flows resulting ensure that both bearing elements, the “stator” and the “rotor” are separated by a stream of gas or air. In this way, practically frictionless movements can be achieved.

A rheometer with a gas bearing of the type described, in which the stator is equipped with multiple holes that distribute the air inside the stator to enable uniform exit of air from the stator to the bearing gap is described in DE 102 47 783 B4. In this case, the stator consists of an air-permeable material, forming a very large number of tiny nozzles that open into the bearing gap.

For the rotor attached to the shaft, which according to DE 102 47 783 B4 is constructed in the form of a disc extending radially to the shaft, it is common to use metallic, gas-impermeable materials, wherein there is a constructional requirement to make the rotor as smooth as possible, i.e., with no roughness of any kind to the extent possible, since any uneven or rough site on the surface interacts with the air flowing in the bearing gap and creates a disturbance torque that adversely affects the movement of the rotor and consequently the shaft and thus the measurement accuracy of the rheometer.

In order to avoid disturbance torques or adhesion effects, the surfaces of the rotor that confine the bearing gap should have no damage, scratches or geometric deviations. However, the processing necessary to achieve this condition using extremely high precision machinery involves heavy costs, which increases the manufacturing cost of the stator.

Attempts have been made to provide the rotor with an additional surface coating to improve the surface quality post mechanical surface treatment. The additional coating process increases the manufacturing costs, and there is a risk that the coating itself will be applied improperly leading to geometrical deviations and surface defects on the rotor making it unusable.

The primary task of the invention is to create a rheometer with a gas bearing of the type described, which can be manufactured easily and ensures a precise flow of gas in the bearing gap.

According to the invention this task is accomplished with a rheometer having a gas bearing with the features of claim 1. It is further provided that at least the areas of the first bearing element (rotor) close to the second bearing element (stator) are made of a gas-permeable material, into which the gas penetrates and preferably forms a static gaseous layer near the surface due to the dynamic pressure or backpressure of the gas. In particular, it is provided that the first bearing element (rotor) is made entirely or at least almost entirely of the gas-permeable material, which may, for instance, be a sintered material, such as sintered carbon in particular, or a graphite material, particularly synthetic graphite or ceramic.

The first bearing element (rotor) thus has an open porosity, at least in the surface limiting the bearing gap, while the air introduced through the second bearing element (stator) penetrates the open pores of the first bearing element (rotor). In this context, due to the dynamic pressure or the backpressure of the gas, a static gaseous layer is formed on the surface of the first bearing element (rotor) with the result that the gas flowing, is not longer able to get into the first bearing element (rotor) and is diverted longitudinally along the bearing gap, on this layer of gas. As a result of the formation of the gaseous layer, the first bearing element (rotor) no longer receives a direct gas inflow, and the air resistance that occurs when the shaft and the first bearing element (rotor) are rotated is considerably lower than that in conventional rotors made from a metallic material.

The second bearing element (stator) is also made of porous material and thus has large number of very small nozzles positioned sided by side. The gas pressure that is exerted causes the gas to flow through these nozzles continuously and evenly into the bearing gap from all points along the circumference. This inflowing gas creates a flowing gas cushion on the wall of the second bearing element (stator), so that the gas stream developing in the bearing gap cannot come into contact with the surface of the second bearing element (stator), because the gas pressure on the surface of the second bearing element (stator) is greater than the pressure in the gas stream.

Since the first bearing element (rotor) on the opposite side also consists of porous material and has a large number of small nozzles, although the gas cannot flow through these entirely because of their enclosed configuration, the gas flowing out of the second bearing element (stator) will initially fill the nozzles of the first bearing element (rotor), and the gas flowing back builds up the dynamic pressure described earlier, so that the gas that follows is no longer able to penetrate the porous structure of the first bearing element (rotor) and is diverted along the bearing gap longitudinally due to the dynamic pressure.

Preferably, the same material is used for the first bearing element (rotor) and the second bearing element (stator). Both of these materials should behave identically at least in terms of thermal expansion, or the coefficients of thermal expansion of the materials used should not differ from one another by more than ±15%.

In one possible variant of the invention, it may be provided that an isostatically pressed graphite with chip-breaking and self-lubricating properties is used as the sintered material particularly for the first bearing element (rotor). These two material properties together make an economical implementation possible with the help of various manufacturing processes (ultra-high precision machining, lapping or calibrating). The chip-breaking property is defined via the open porosity (8% by vol. to 16% by vol.) and the average grain size is in the range of 2 μm to 12 μm.

In one possible variant of the invention it may be provided that in a radial plane the cross-sectional area of the bearing gap measured in the axial end regions is equal to the corresponding cross-sectional area in its axial central region. In such a case, the bearing gap in particular is geometrically dimensioned such that the gas flow in the axial end regions of the bearing gap is equal to the gas flow in the axial central region. The flow velocity is preferably also the same in the outlet cross-sections of the bearing gap and in the axial end regions thereof.

In a further development of the invention, it may be provided that at least sections of the shaft are designed as a hollow shaft with an axial channel, and that the axial channel communicates with the bearing gap via at least one connecting channel that passes through the first bearing element (rotor).

For the purposes of this invention, the term “axial” always refers to the longitudinal axis of the shaft of the rheostat, which is usually aligned vertically. Similarly, the term “radial” denotes a direction extending perpendicularly to the longitudinal axis of the shaft.

A predetermined quantity of gas may flow through the communicating channel into the axial channel of the shaft in a defined manner, and then flows out of the shaft along the axial channel. In this way, a discharge of the exhaust gas is possible primarily from a middle region of the bearing gap.

Good adjustability of the bearing properties of the gas bearing can be achieved if it is provided in a further development of the invention that at least one adjustable throttle is positioned in the axial channel and/or downstream to the channel in the direction of flow. The throttle may be used to adjust and vary the flow conditions in the bearing gap with a view to ease movement, reduce breakaway torques to the extent possible, and control stiffness, load bearing capacity and damping.

At the same time the exhaust gas may be used to dissipate heat from the bearing gap and to cool the drive of the shaft arranged away from the gas bearing to counteract uneven running properties of the gas bearing due to overheating.

Besides the porosity of the material, it may also be provided that at least one feed channel and in particular several feed channels are formed in the second bearing element (stator), via which the supplied gas may be distributed in the second bearing element (stator) as evenly as possible and in particular over the entire circumference.

In a preferred embodiment of the invention, it is provided that the one or more feed channels comprise of at least two arms of the supply channel that are entirely independent of each other in terms of fluid flow, each having its own gas supply. In particular, the gas quantities supplied to each of the supply channel arms and the corresponding gas pressures may be set independently. By doing so, the flow conditions in the section of the second bearing element (stator) that is allocated to one supply channel arm can be varied and adjusted relative to the section of the second bearing element (stator) that is allocated to the other supply channel arm. In this way, it is possible to compensate for inhomogeneities in the material and the manufacturing tolerances in the porous second bearing element (stator) and local variations in the flow conditions in the second bearing element (stator).

In a further development of the invention, it may be provided that the supply channel arms in the axial direction of the second bearing element (stator) are positioned away from each other. This has the further advantage, specifically that it is possible to make an axial adjustment of the first bearing element (rotor) and consequently of the shaft, relative to the second bearing element (stator) using different actuations of the two supply channel arms (different gas quantities and/or different flow velocities).

In a further development of the invention, a regulating device may also be provided that detects the axial position of the shaft and also of the first bearing element (rotor) by means of a sensor and keeps the shaft in a predetermined axial position automatically by actuating the supply channel arms.

The desired amount of gas and the flow velocity within the supply channel arms can be adjusted using the corresponding control valves or throttles upstream of the supply channel arms. It may also be provided that a corresponding throttle is placed in at least one of the supply channel arms and preferably in all of the supply channel arms.

In a preferred variant of the invention, it is provided that the surface of the first bearing element (rotor) facing the gap is furnished with at least one circumferential groove. The groove created in the surface of the first bearing element (rotor) together with the gas discharge line through the communication channel can influence the shape and dimension of the gaseous layer that is formed as a result of the dynamic pressure, and this consequently increases the stiffness and tilt stability of the bearing.

In general, there are various geometric shapes that can be used to shape the first bearing element (rotor). In a variant of the invention, it may be provided that the first bearing element (rotor) has at least one spherical element in the form of a spherical segment or with a spherical segment-like shape. In particular, the first bearing element (rotor) consists of two spherical elements in the form of a spherical segment or with a spherical segment-like shape, which are arranged axially one behind the other in such a way that the smaller, flat surfaces thereof are facing each other or lying flush against each other. In this context, parts of the element may be arranged directly over each other, but it is also possible to place at least one spacer between the two parts of the element.

Alternatively, the first bearing element (rotor) may have at least one element in the shape of a truncated right circular cone. Preferably, the first bearing element (rotor) has two parts in the form of a truncated right circular cone, which are arranged axially one behind the other, so that the smaller, flat surfaces thereof face each other or lie flush with each other. In this context, parts of the element may be arranged directly over each other, but it is also possible to place at least one spacer between the two parts of the element.

In the variants described, the first bearing element (rotor) has the shape of either double-hemispherical shells or spherical segment shells or the shape of a double cone or double cone frustum.

In an alternative variation of the invention, it may be provided that the first bearing element (rotor) has at least one element part in the form of a tubular porous sleeve that surrounds the shaft.

The first bearing element (rotor) may also be formed from a combination of the above geometries, and comprises at least one spherical part and/or at least one part in the form of a right circular truncated cone and/or at least one part in the form of a tubular, preferably circular-cylindrical sleeve.

The gas introduced via the second bearing element (stator) does not flow through the surface areas of the first bearing element (rotor), which are outside of the bearing gap, that is to say for example, the surface regions aligned axially. To prevent an excessive quantity of gas from escaping through the surface of the first bearing element (rotor) outside of the bearing gap, it may preferably be provided that these surfaces are at least partly or entirely provided with a cover. The cover may be impermeable to gas or it may also have a predefined permeability. The covers may help to ensure that the gas entering the surfaces of the first bearing element (rotor) that confine the bearing gap, is accumulated inside the first bearing element (rotor) and does not flow away in an uncontrolled manner so that a precisely defined layer of gas can be created in the region of the bearing gap on the surface of the first bearing element (rotor).

Further advantages and features of the invention will be evident from the following description of exemplary embodiments with reference to the drawing. The drawings show:

a schematic vertical section through a gas bearing of a rheometer shaft specified in this invention,

an enlarged view of the gas flow that is set up and the gaseous layer close to the surface,

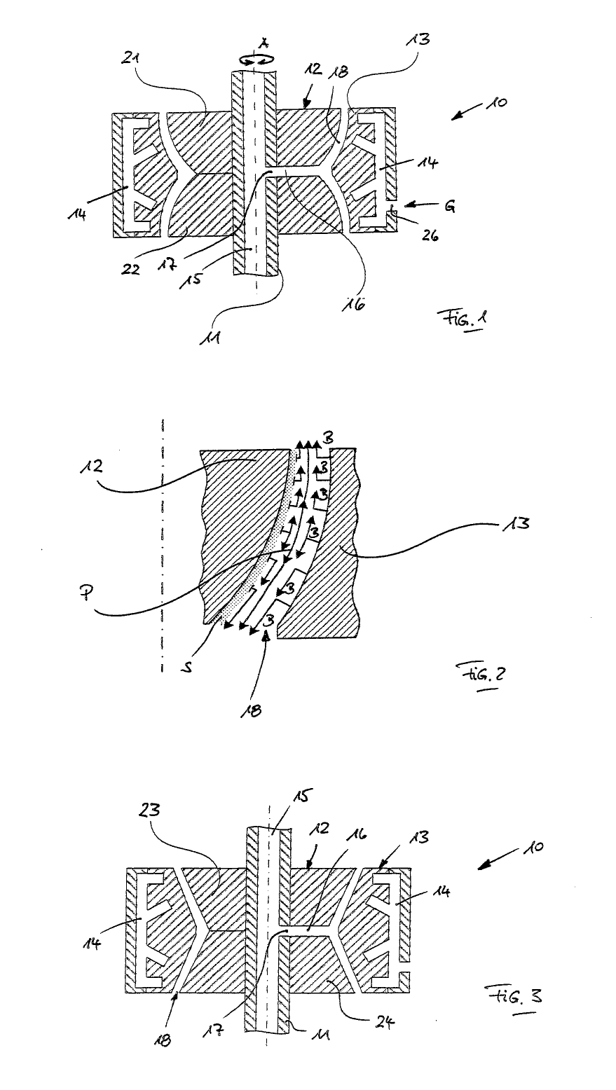

a first variation of the design indicated in FIG. 1

a second variation of the design as indicated in FIG. 1

a subsequent development of the design shown in FIG. 4,

a second further development of the design shown in 4,

a third development of the design shown in FIG. 4,

an enlarged view of the bearing gap, and

a schematic vertical section through a gas bearing of a rheometer shaft according to a further embodiment of the invention.

FIG. 1 shows a vertical section through a gas bearing 10 of a rheometer shaft 11 that is essentially aligned vertically. The shaft is driven in a rotary direction, as indicated by the double-headed arrow A in FIG. 1. The first bearing element (rotor) 12 is seated on the shaft and is attached firmly to the shaft 11 and includes two spherical parts 21, 22, each of which has a layer of spheres, wherein the said parts 21, 22 are arranged one behind the other on the shaft 11 in the axial direction such that their smaller flat surfaces lie flush against one another.

Shaft 11 is configured as a hollow shaft and has an axial channel 15 extending along the longitudinal direction of shaft 11, and this channel is linked to the connecting channel 16 that extends essentially radially to shaft 11 and this link is via a radial bore 17 in the wall of shaft 11. The connecting channel 16 extends linearly in the region of the contact surface between the two spherical parts 21, 22 of the element.

Shaft 11 is preferably made from a metallic material, and first bearing element 12 (rotor) is made from a gas-permeable material, particularly a sintered material, a graphite material or ceramic.

The first bearing element (rotor) 12 is surrounded by a second bearing element (stator) 13 with a space in between, wherein a bearing gap 18 is formed between the outer surface of the first bearing element (rotor) 12 and the inner surface of the second bearing element (stator) 13.

The second bearing element (stator) 13 is made of a gas-permeable material of the type described. In addition, feed channels 14 are formed inside the second bearing element (stator) 13, and the feed channels 14 have a fluidic connection with an inlet opening 26. A gas (arrow G) is introduced into feed channels 14 through the inlet opening 26 and spreads across the channels over the entire circumference of the second bearing element (stator) 13. Because of the resulting gas pressure and the gas permeability and porosity of the second bearing element (stator) 13, the supplied gas exits at the surface of the second bearing element (stator) 13 facing the first bearing element (rotor) 12 into several small nozzles distributed evenly about the circumference thereof, as indicated by arrows B in FIG. 2. The air exiting the second bearing element (stator) 13 infiltrates the porous surface of the first bearing element (rotor) 12 on the opposite side of bearing gap 18. As a result, however, a backpressure of the gas is generated, forming a static gaseous layer S indicated in FIG. 2, over the entire surface of first bearing element (rotor) 12 that confines the bearing gap 18.

Gas that subsequently exits the second bearing element (stator 13) is unable to pass through gaseous layer S and then flows along the bearing gap 18 either—as shown in FIG. 2—upwards to the axial outlet of the bearing gap 18 or downwards to the transition area between the two spherical parts of the element as shown in FIG. 2 and then enters the connecting channel 16, flows through the radial bore 17 into the axial channel 15 of the shaft 11, and is dissipated through this.

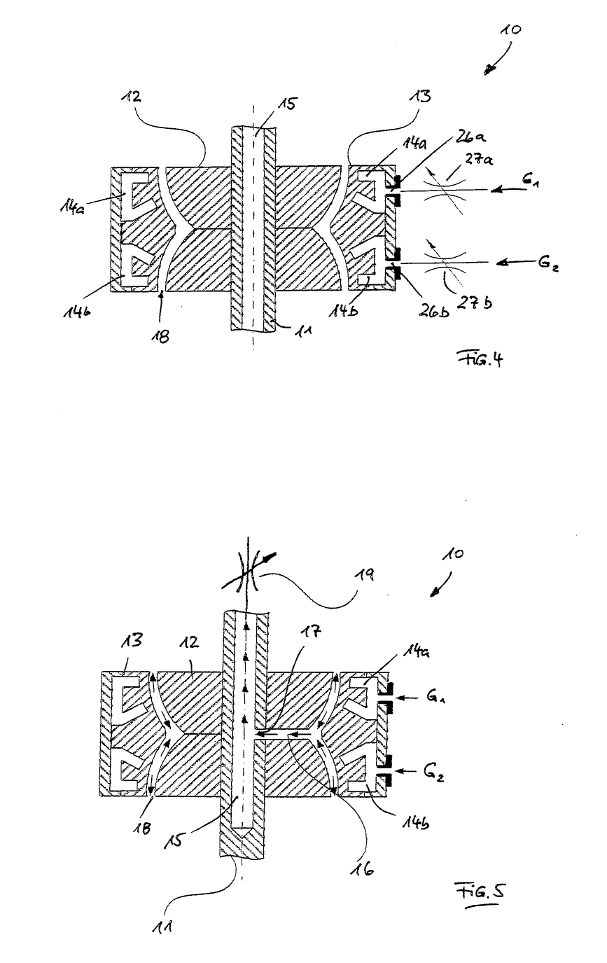

FIG. 3 shows a first variant of the embodiment shown in FIG. 1. The gas bearing 10 shown in FIG. 3 differs from the one in FIG. 1 only in that the first bearing element (rotor 12) in this case consists of two parts, each in the form of a right circular truncated cone, wherein the right circular truncated cones are arranged one behind the other in the axial direction of the shaft 11 in such manner that the smaller, flat surfaces thereof lie flush against one another. Consequently, instead of a bidirectionally curved course, bearing gap 18 then has two straight sections which merge into each other in the area of the contact surface of the two right circular truncated cones 23, 24.

FIG. 4 shows a further variation of the design of gas bearing 10 shown in FIG. 1 and differs from it in that the feed channels 14 inside the second bearing element (stator 13) are divided into two feed channel arms 14a and 14b which are designed completely independent of each other for fluid flow purposes and are placed at a distance from each other in the axial direction of the second bearing element (stator 13), and each of them has an inlet opening 26a, 26b for a gas stream G₁ and G₂. A throttle 27a and 27b are arranged in the corresponding gas line upstream to the respective inlet openings 26a, 26b. This enables different quantities of gas to be supplied to the supply channel arms 14a and 14b at different gas pressures and with different flow velocities. Consequently, the gas exits from axially separated surface of the bearing gap 18 under different conditions, which in turn may lead to a desired axial displacement of the first bearing element (rotor 12) and with it the displacement of the shaft 11.

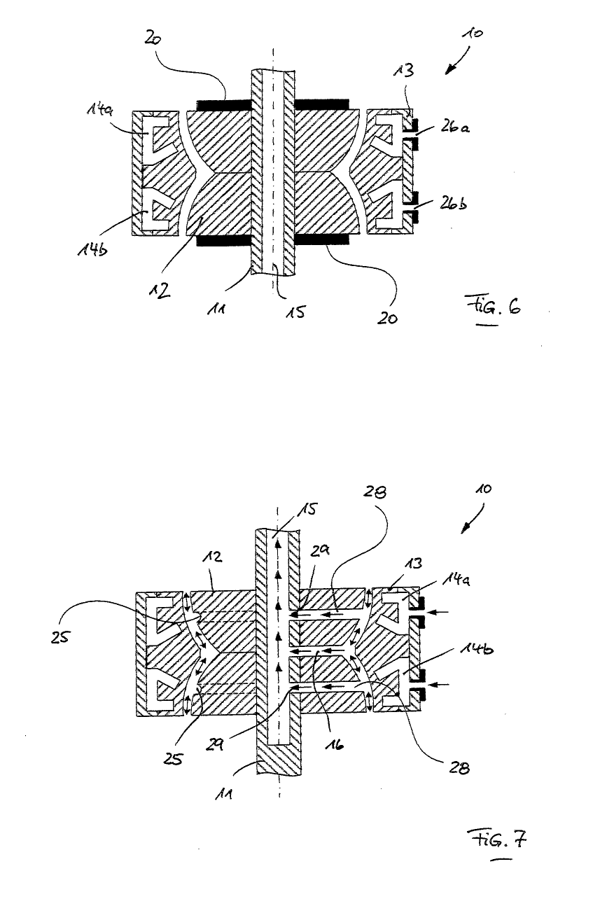

FIG. 5 shows a further development of the embodiment of gas bearing 10 shown in FIG. 4 and differs from the latter in that the lower end of shaft 11 as shown in FIG. 5 is sealed, such that the gas which enters the axial channel 15 of shaft 11 through the connecting channel 16 and the radial bore 17 can only escape from the shaft by flowing axially upwards, as shown in FIG. 5. A throttle 19 is positioned in the gas line in the upper area of shaft 11 or downstream to the shaft 11, and this throttle adjusts and varies the flow and pressure conditions in the axial channel 15, and also in the bearing gap 18.

FIG. 6 shows a second development of the embodiment of the gas bearing 10 shown in FIG. 4, which differs from the latter essentially in that the surfaces of the first bearing element (rotor) 12 that are outside of bearing gap 18 and are oriented axially are covered with a cover 20, and preferably sealed to make them gas-tight. The cover 20, which may either be a cover or a coating, may alternatively be permeable to gas, wherein the material of the cover 20 must still be less permeable to gas than the material of the first bearing element (rotor) 12.

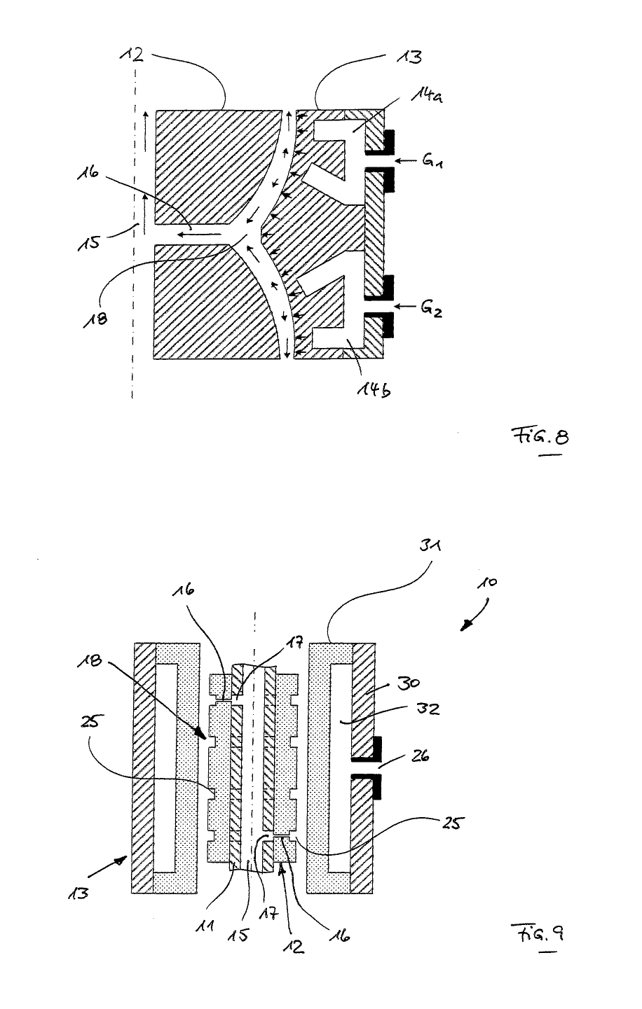

FIG. 7 shows another development of the design of gas bearing 10 depicted in FIG. 4 and differs from the latter essentially in that besides the connecting channel 16, which extends into the region of the contact surface of the two spherical parts 21 and 22 of the element, further radial connecting channels 28 are formed, and they extend parallel to and at a distance from the connecting channel 26, and each of them is connected to the axial channel 15 formed inside the shaft 11 via a radial bore 29. In addition, grooves 25 are formed on the outer surface of the first bearing element (rotor 12) facing the bearing gap 18 and extend around the entire circumference thereof in order to guide the gas.

FIG. 8 shows an enlarged view of the bearing gap 18 formed between the first bearing element (rotor) 12 and the second bearing element (stator) 13. This shows that the radial width of the cross section of the bearing gap 18 becomes consistently smaller, starting from the axial middle region thereof, in which the connecting channel 16 branches off, in the direction of the axial end regions thereof, in which the gas stream exits bearing gap 18. Since the distance from the central axis—i.e. the radius—is increasing at the same time, the reduction from the circumferential perspective is balanced out. In this context, the bearing gap 18 is geometrically dimensioned in such a manner that the gas flow rate is the same at the axial outlet cross sections and at the inlet cross section in the connecting channel 16. This configuration ensures a high degree of tilt stability with a good load-bearing capacity.

FIG. 9 shows a modified structure of the gas bearing of a rheometer. Here, sections of shaft 11 are surrounded by a first bearing element (rotor) 12 and connected to it. This bearing element is made from a gas-permeable material of the type described earlier, and is essentially tubular. It has several radial connecting channels 16 that connect the outside of the first bearing element (rotor) 12 to the internal axial channel 15 of shaft 11. In addition, multiple grooves 25 are provided at a distance from each other in the axial direction of the shaft 11 and extending over the outer surface of the first bearing element (rotor) 12.

The external second bearing element (stator) 13 has a primarily metallic stator housing 30 with a gas inlet port 26 of the type described earlier. An essentially cylindrical stator insert 31 is positioned on the side of the stator housing 30 facing the shaft 11, and essentially surrounds the first bearing element (rotor) 12 to form a bearing gap 18, and is made of a gas-permeable material. A stator chamber 32 is formed on the side of the stator insert facing away from the shaft 11 and can be filled with gas via the outlet opening 26. Under the effect of the gas pressure exerted, the gas in the stator chamber 32 spreads throughout the entire circumference of the bearing element (rotor) 12 and flows through stator insert 31, thus forming the gas stream in the bearing gap 18 that supports shaft 11.

The preceding text described various design variants of the gas bearing of a rheometer. It should be noted that it is also possible within the scope of the invention to apply each individual feature of each individual embodiment to all the other embodiments, i.e. to implement the individual features in any combination, provided the basic idea of the invention is realised. A limitation to the described exemplary embodiments is neither suggested nor desired according to the invention.

1. A rheometer having a shaft which is supported rotatably in a gas bearing, wherein the gas bearing comprises a first bearing element attached to the shaft and a second bearing element that surrounds the first bearing element with a space in between, forming a bearing gap, wherein at least sections of the second bearing element are made from a gas-permeable material, through which the gas flows in such manner that a gas cushion (P) is formed in the bearing gap, by which the first bearing element and the shaft are supported without any direct contact, and wherein the first bearing element comprises a gas-permeable material at least in those regions facing the second bearing element, and the gas penetrates the material forming a gaseous layer (S) close to the surface as a result of the dynamic pressure or backpressure of the gas.

2. The rheometer according to claim 1, wherein the first bearing element is entirely or at least almost entirely made of the gas-permeable material.

3. The rheometer in according to claim 1, wherein the gas-permeable material is a sintered material or a graphite material or ceramic.

4. The rheometer according to claim 1, wherein the cross-sectional area of the bearing gap measured in a radial plane is equal in the axial end to the corresponding cross-sectional area in its axial central portion.

5. The rheometer according to claim 1, wherein at least sections of the shaft are designed as a hollow shaft with an axial channel, and that the axial channel is linked to the bearing gap via at least one connecting channel that passes through the first bearing element.

6. The rheometer according to claim 5, wherein at least one adjustable throttle is positioned in the axial channel and/or downstream to the channel in the direction of flow.

7. The rheometer according to claim 1, wherein at least one feed channel is formed in the second bearing element, through which a supplied gas (G) can be spread over the entire circumference inside the second bearing element.

8. The rheometer according to claim 7, wherein the supply channel comprises at least two supply channel arms that are entirely independent of each other in terms of fluid flow, each having its own gas supply (G₁, G₂).

9. The rheometer according to claim 8, wherein the supply channel arms are arranged a distance from each other in the axial direction of the second bearing element.

10. The rheometer according to claim 7, wherein a throttle is positioned in at least one of the supply channel arms.

11. The rheometer according to claim 1, wherein the first bearing element has at least one circumferential groove on the surface thereof facing the bearing gap.

12. The rheometer according to claim 1, wherein the first bearing element has at least one spherical part that is in the form of a spherical segment or has a spherical segment-like shape.

13. The rheometer according to claim 12, wherein the first bearing element has two spherical parts in the form of a spherical segment or having a spherical segment-like shape, which are positioned axially one behind the other so that their smaller, flat surfaces face each other or lie flush against each other.

14. The rheometer according to claim 1, wherein the first bearing element has at least one part in the shape of a truncated right circular cone.

15. The rheometer according to claim 14, wherein the first bearing element has two element parts in the shape of truncated right circular cones, which are arranged axially one behind the other such that their smaller, flat surfaces are face each other or lie flush against each other.

16. The rheometer according to claim 1, wherein the first bearing element has at least one part that is in the shape of a tubular, porous sleeve and surrounds the shaft.

17. The rheometer according to claim 1, wherein the first bearing element has at least one spherical part and/or at least one part in the shape of a truncated right circular cone and/or at least one part in the shape of a tubular sleeve.

18. The rheometer according to claim 1, wherein at least sections of the surface of the first bearing element that are outside of the bearing gap are covered and/or sealed by a cover.
